(19) United States
(12) Patent Application Publication
(10) Pub. No.: US 2003/0154171 A1
(43) Pub. Date: Aug. 14, 2003

(54) Apparatus and method for selling personal information

(75) Inventors: Alan H. Karp, Palo Alto, CA (US); Rajiv Gupta, Los Altos, CA (US); Arindam Banerji, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT PACKARD COMPANY

(21) Appl. No.: 09/539,558

(22) Filed: Mar. 31, 2000

(51) Int. Cl. G06F 17/60

(52) U.S. Cl. 705/78

(57) ABSTRACT

A system for selling personal information through a trusted third party. An owner of the personal information provides policy governing the sale of the owner's personal information and authorizes information sources to provide the personal information to the trusted third party. The trusted third party provides for validation of the personal information and sells it to requesters in accordance with the policy, and provides payment or credit to the owner as compensation for the sale.

### FIELD OF THE INVENTION

The present invention relates to an apparatus and method for managing the sale of personal information between the owner of the personal information and a requestor of that information.

### BACKGROUND OF THE INVENTION

Much personal information today is compiled, for example, by credit card companies and maintained in databases. Credit card companies can track and record credit card purchases including the item purchased, the date purchased, the amount, and the place of the purchase. The recorded information is used for billing purposes. Other types of personal information may be gathered by other entities. For example, Internet browser applications may track computer users on-line browsing and shopping habits, including web sites visited and purchases made. Much of this personal information is already maintained in computer databases, and some of it is given away for free. However, this personal information is often maintained in confidence and may not be released by the credit card companies or other entities.

In order to gather personal information on a particular person, an Internet search may be performed for information on that person. Alternatively, the information may be requested directly from the person generating it. However, those sources may not necessarily be reliable since the information is received directly from the person or from an unreliable third source. Also, if a private search firm were used, the person receives no payment for the sale of his or her personal information gathered by the search firm. Since the personal information is typically already gathered, if persons were to authorize its release by a trusted third party, they could obtain payment for their personal information.

Accordingly, a need exists for an apparatus method for managing the sale of personal information.

### SUMMARY OF THE INVENTION

A method consistent with the present invention provides for selling personal information. It includes receiving personal information of an owner and specifying, possibly by the owner, a policy related to sale of the personal information. In response to a request, the personal information is validated and selectively provided based upon the policy.

Another method consistent with the present invention also provides for selling personal information. It includes receiving from a requester a request for personal information of a particular owner and specifying a policy related to sale of the personal information. The personal information is validated through a trusted third party, which also determines if the requestor is permitted to receive the requested personal information based upon the policy. The trusted third party provides the requested personal information to the requestor if the requestor is permitted to receive it.

### BRIEF DESCRIPTION OF THE DRAWINGS

The accompanying drawings are incorporated in and constitute a part of this specification and, together with the description, explain the advantages and principles of the invention. In the drawings,

FIG. 1A is a diagram of a business method for selling personal information;

FIG. 1B is a diagram of a network for implementing a system for selling personal information;

FIG. 2A is a flow chart of a home page routine for use in selling personal information;

FIG. 2B is a flow chart of a personal information page routine;

FIG. 2C is a flow chart of a search routine;

FIGS. 2D and 2E are a flow chart of a request for personal information routine;

FIG. 3A is a diagram of a personal information home page screen;

FIG. 3B is a diagram of a personal information policy screen;

FIG. 3C is a diagram of a search personal information owners screen;

FIG. 3D is a diagram of a search results screen;

FIG. 3E is diagram of a personal information request screen;

FIG. 3F is a diagram of a personal information cost screen; and

FIG. 3G is a diagram of a personal information results screen.

### DETAILED DESCRIPTION

### Overview

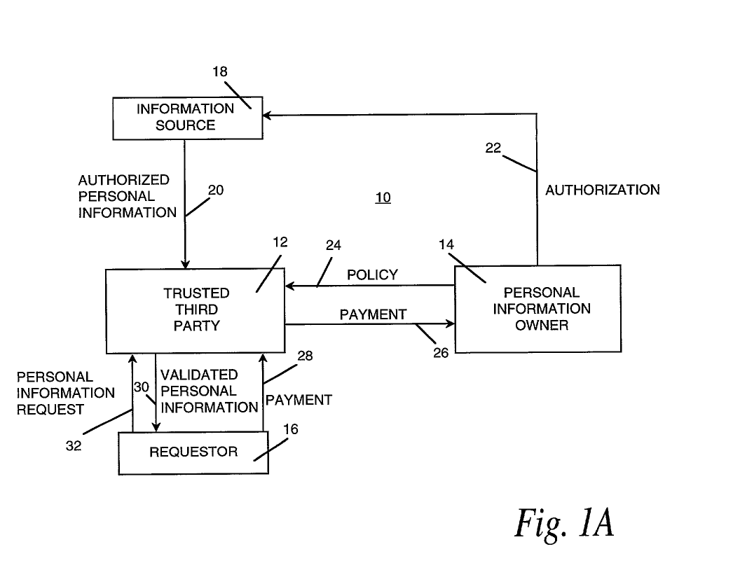

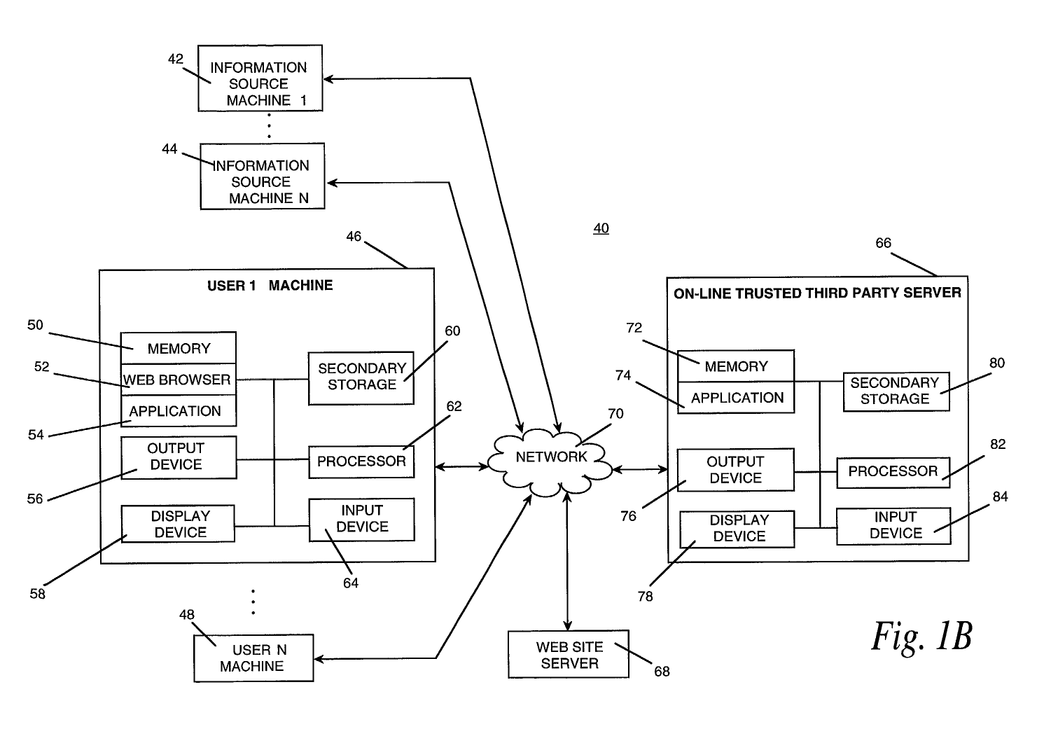

FIG. 1A is diagram of a business method 10 for selling personal information. This method makes use of, for example, the vast array of personal information already stored within databases of third parties such as credit card companies or available from other third parties. In this method, a trusted third party provides validation of personal information in order to provide a certain level of authenticity of it. In addition, the trusted third party provides for managing the personal information by processing requests for it and obtaining payment for the personal information, and providing payment or credit to the owner. Accordingly, use of a third party may result in a greater degree of authenticity then if the personal information were obtained directly from the owner of it.

As shown, method 10 involves use of a trusted third party 12 interacting with an owner 14, a requestor 16, and an information source 18. The trusted third party 12 may be any entity which can manage and sell personal information. Examples include credit card companies, which typically already have the processing capability to track such items as credit card purchases and provide for the distribution of that information, if authorized and requested. Other entities may exist for compiling and maintaining personal information. The requestor 16 represents a person or entity requesting the personal information of a certain individual or group, referred to as the “owner.” Therefore, owner 14 represents a person or group who has generated or is otherwise associated with personal information that may be offered for sale.

Information source 18 represents sources of the personal information of owner 14. One such source may be a credit card company issuing a credit card and maintaining a credit account for the owner 14. Therefore, trusted third party 12 and information source 18 may exist within the same entity. For example, the credit card company has the ability to track and record credit card purchases made by owner 14 and thus may be a source of the personal information of that person.

Other information sources 18 may include any source of personal information generated by or associated with owner 14. For example, another information source 18 may constitute a bank issuing a mortgage to owner 14 and, with appropriate authorization, the bank may provide to trusted third party 12 information concerning the mortgage or other loans maintained by owner 14. The bank could also provide indications of deposits and withdrawals. Another example of an information source 18 is a payroll service that, with appropriate authorization, may provide to trusted third party 12 salary or earnings information of owner 14. Other information sources 18 could include any source of assets maintained by owner 14, such as financial services firms, stock trading firms, and mutual fund firms. It may also include other entities that may track behavior of owner 14. For example, certain on-line services or web browsers may track the browsing or on-line shopping habits of owner 14, and those entities with appropriate authorization may provide to trusted third party 12 such personal information of owner 14.

In use, owner 14 provides authorization 22 to one or more information sources 18. Information sources 18 and trusted third party 12 may reside within the same or different physical entities; for example, the same credit card processing server can both function as the trusted third party and function as an information source by recording credit card transactions. With that authorization, information source 18 may transmit to trusted third party 12 authorized personal information 20 of the owner 14. The information 20 may be provided electronically over a wireline or wireless computer network such as the Internet, or through any other method of distribution. Requestor 16 makes a personal information request 32 to trusted third party 12. The personal information request 32 specifies the identity of a particular owner 14 whose personal information is of interest to requestor 16. Requestor 16 can make the request 32 through a computer network, such as the Internet, or through any wireline or wireless communication such as through use of a telephone, cellular telephone, or Internet appliance.

Based upon a policy 24 received from owner 14 or a default policy, trusted third party 12 determines whether requester 16 is permitted to receive the requested information. Policy 24 specifies conditions under which trusted third party 12 can provide the personal information of owner 14, possibly including the cost of the information. The term “policy” thus includes any information specifying conditions under which personal information is permitted to be sold.

If requestor 16 is permitted to receive the requested personal information, trusted third party 12 provides validated personal information 30 to requestor 16. The validation of the personal information occurs by receipt of the information through a source other than directly from the owner. For example, the information is received from a bank or other financial institution, or recorded by a credit card company. Therefore, the term “validated personal information” and the act of validating personal information means that it is not received directly from the owner of the personal information. The owner likely generates the personal information through, for example, making credit card purchases, obtaining loans, receiving financial assets, or engaging in on-line browsing or shopping. However, another entity is typically involved in those actions to record or provide the personal information generated by the owner. The validation thus provides the personal information with a particular degree of authenticity, potentially increasing its value. Also, a “trusted third party” can be any entity, other than the owner, capable of validating the personal information or providing validated personal information for sale.

Requestor 16 also provides payment 28 for the personal information such as through use of an electronic payment. The payment is made for the cost of the personal information, and the cost is typically specified as a monetary amount. Trusted third party 12 then may provide payment 26 to owner 14 for the sale of the personal information. The payment 26 provided to owner 14 may be implemented with an electronic transaction such as a credit amount applied to a credit card account of owner 14 and maintained by trusted third party 12. In addition, the trusted third party 12 may take a portion of payment 28 for the services provided in validating and managing sale of personal information.

### System for Selling Personal Information

FIG. 1B illustrates an exemplary system 40 for implementing an on-line system for selling personal information according to method 10 illustrated in FIG. 1A. Any type of network or system can implement the method. Use of a network such as the Internet provides for ease of transmission and communication due to the standard Internet protocols, including Transmission Control Protocol/Internet Protocol (TCP/IP), and the use of web browser applications.

System 40 includes information source machines 42 and 44 connected with a network 70 such as the Internet or other network including any wide-area or local-area network. Information source machines 42 and 44 may be used to provide personal information to a trusted third party for processing via a server 66, and those information source machines can physically implement information source 18. User machines 46 and 48 are also connected with network 70. Users or requesters 16 at user machines 46 and 48 may interact with one or more information source machines 42 and 44 and with server 66 in order to request personal information, and enter and view information related to selling personal information. Requestor 16 and owner 14 can use machines 46 and 48 to perform such interaction. The term “user” is intended to include requesters, owners, and others.

Server 66 is connected with network 70 and processes personal information as trusted third party 12. It may receive personal information from information source machines 42 and 44, record personal information directly, receive requests for personal information from user machines 46 and 48, and provide personal information and related information to user machines 46 and 48. System 40 may also include the ability to access one or more web site servers 68 in order to obtain content from the World Wide Web for use with personal information. Only two information source and user machines are shown for illustrative purposes; system 40 may include many information source and user machines, and may be scalable to add or delete information source or user machines to or from the network.

User machine 46 illustrates typical components of a user or information source machine. User machine 46 typically includes a memory 50, a secondary storage device 60, a processor 62, an input device 64, a display device 58, and an output device 56. Memory 50 may include random access memory (RAM) or similar types of memory, and it may store one or more applications 54, and a web browser 52, for execution by processor 62. Secondary storage device 60 may include a hard disk drive, floppy disk drive, CD-ROM drive, or other types of non-volatile data storage. Processor 62 may execute applications or programs stored in memory 50 or secondary storage 60, or received from the Internet or other network 70. Input device 64 may include any device for entering information into machine 46, such as a microphone, digital camera, video recorder or camcorder, keypad, keyboard, cursor-control device, or touch-screen. Display device 58 may include any type of device for presenting visual information such as, for example, a computer monitor, flat-screen display, or display panel. Output device 56 may include any type of device for presenting a hard copy of information, such as a printer, and other types of output devices include speakers or any device for providing information in audio form.

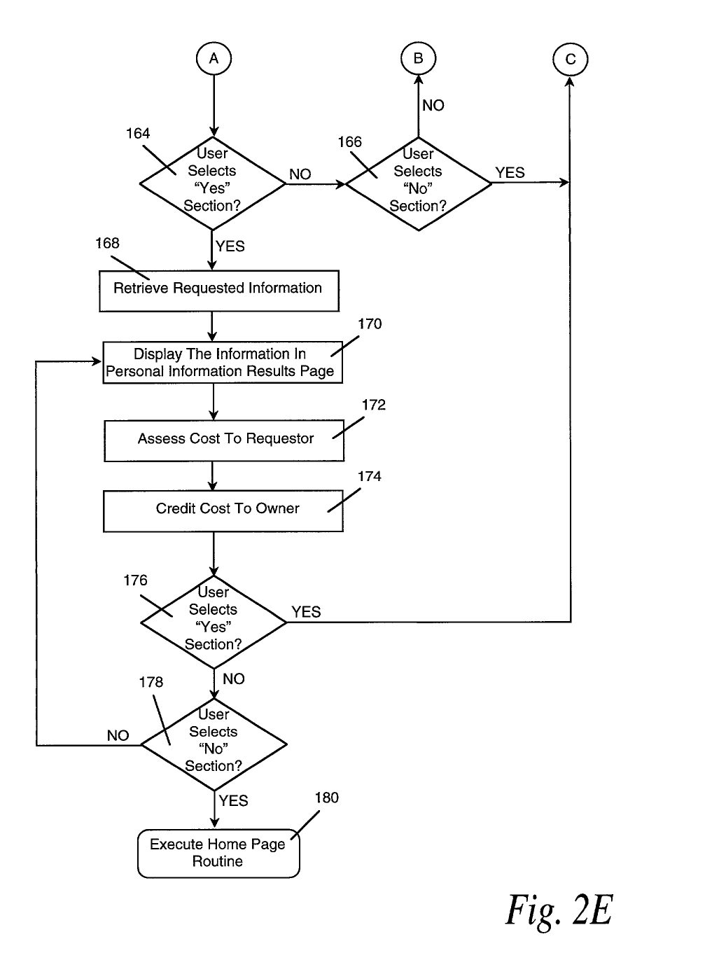

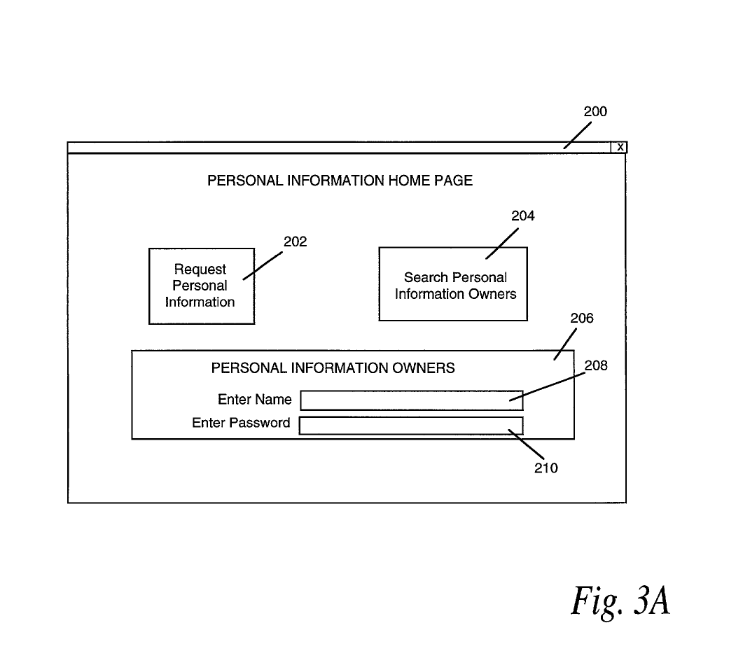

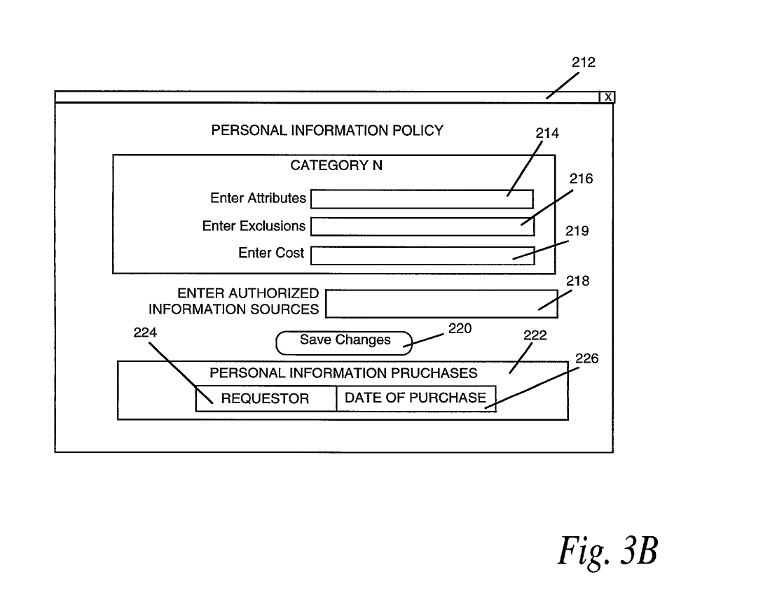

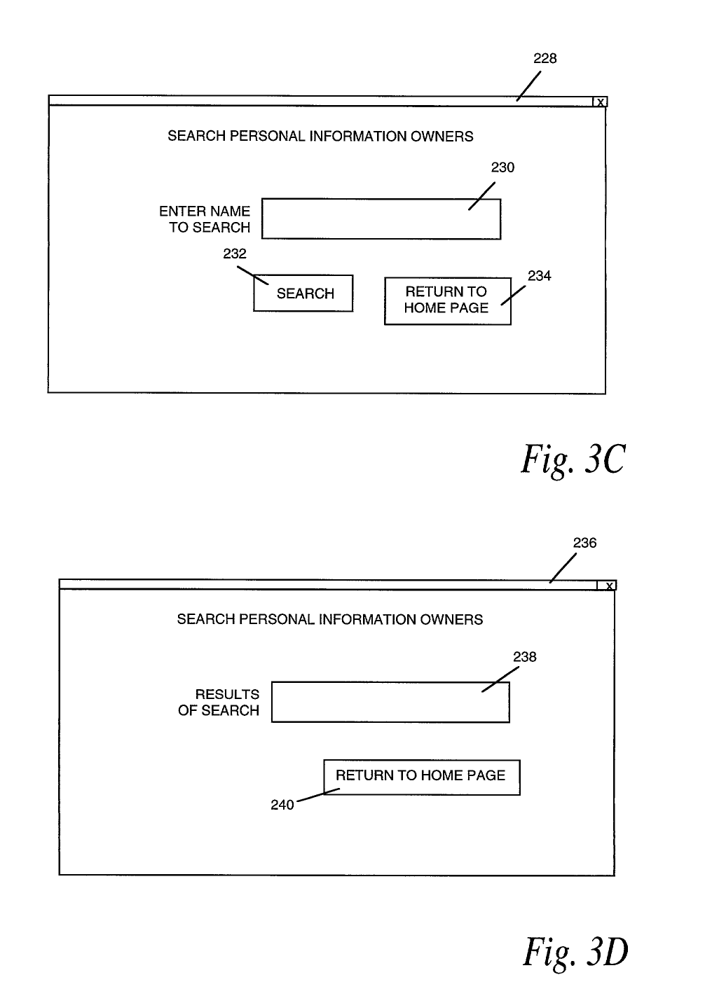

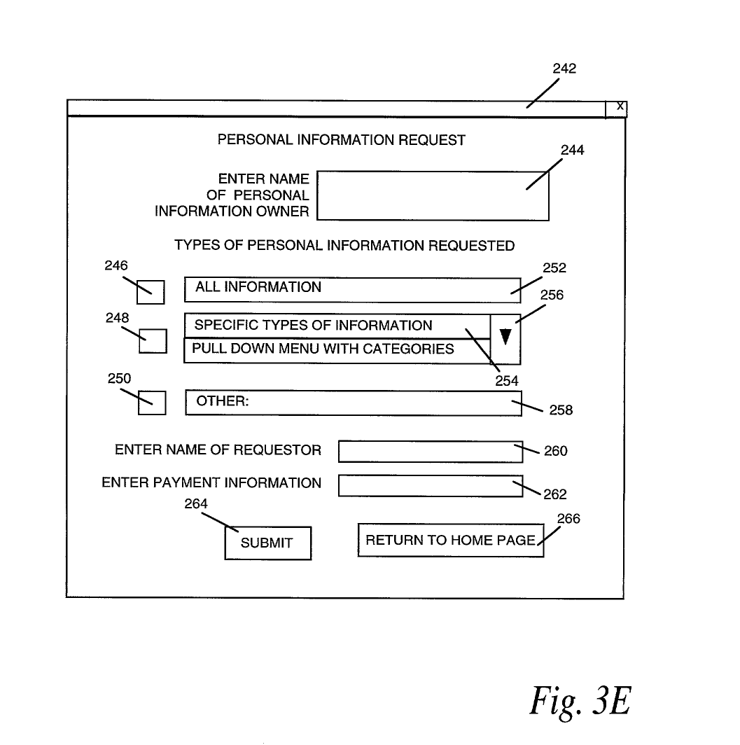

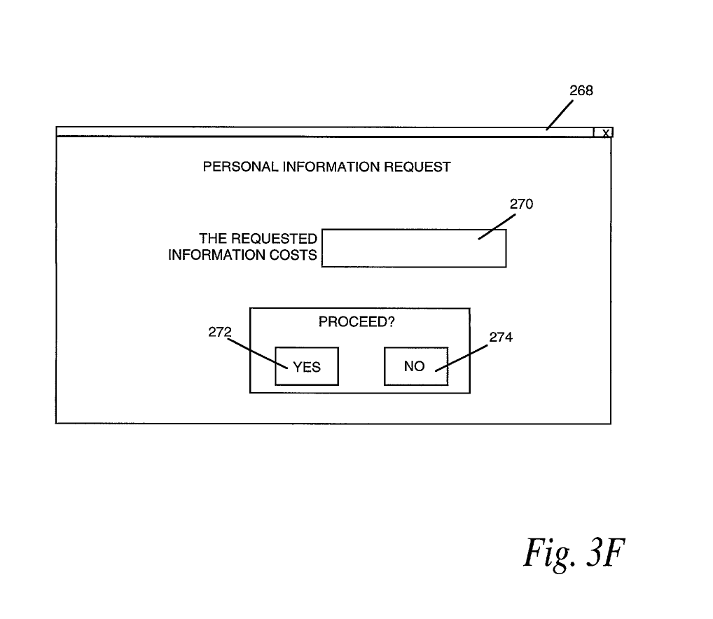

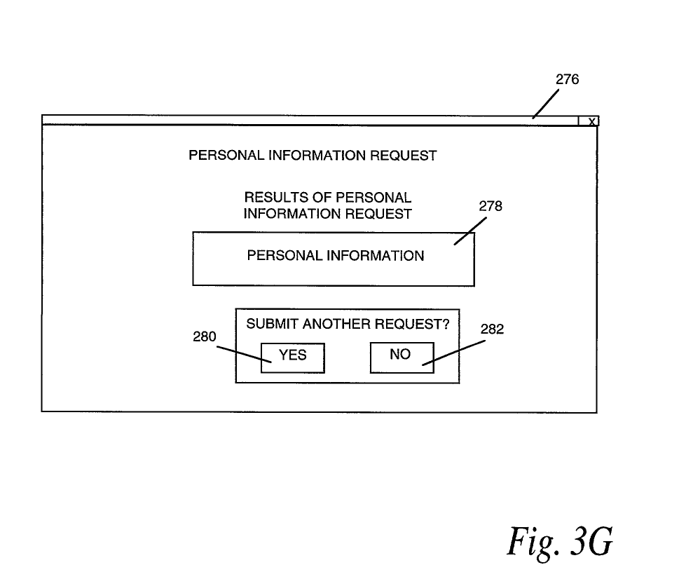

Web browser 52 is used to access information related to sales of personal information and display it in web pages, and examples of those pages are shown in the screens provided in FIGS. 3A-3G. Examples of web browsers include the Netscape Navigator program and the Microsoft Internet Explorer program. Any web browser or other application capable of retrieving content from a network and displaying pages or screens may be used.

Information source machines 42 and 44, and user machine 48, may include the same components as user machine 46. Therefore, examples of user or information source machines for interacting with an on-line system for selling personal information include personal computers, laptop computers, notebook computers, palm top computers, network computers, smart telephones, cellular telephones, Internet appliances, or any processor-controlled device capable of executing a web browser or other type of application for interacting with the system.

Server 66 typically includes a memory 72, a secondary storage device 80, a processor 82, an input device 84, a display device 78, and an output device 76. Memory 72 may include RAM or similar types of memory, and it may store one or more applications 74 for execution by processor 82. Secondary storage device 80 may include a hard disk drive, floppy disk drive, CD-ROM drive, or other types of non-volatile data storage. Processor 82 may execute one or more applications or programs stored in memory 72 or secondary storage 80, or received from the Internet or other network 70. Input device 84 may include any device for entering information into server 66, such as a microphone, digital camera, video recorder or camcorder, keypad, keyboard, cursor-control device, or touch-screen. Display device 78 may include any type of device for presenting visual information such as, for example, a computer monitor, flat-screen display, or display panel. Output device 76 may include any type of device for presenting a hard copy of information, such as a printer, and other types of output devices include speakers or any device for providing information in audio form.

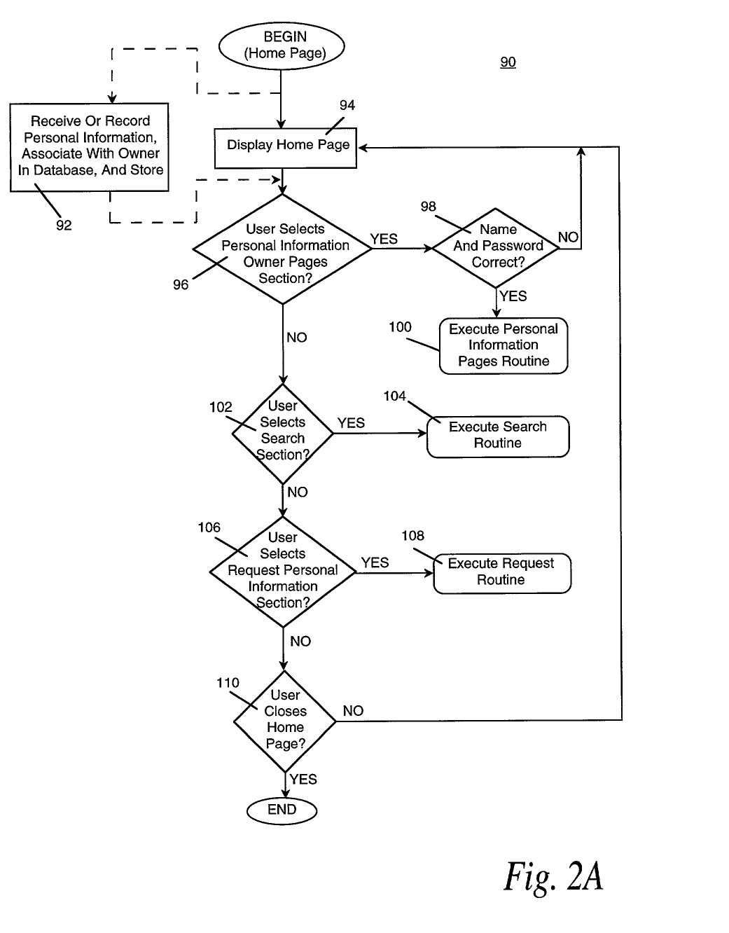

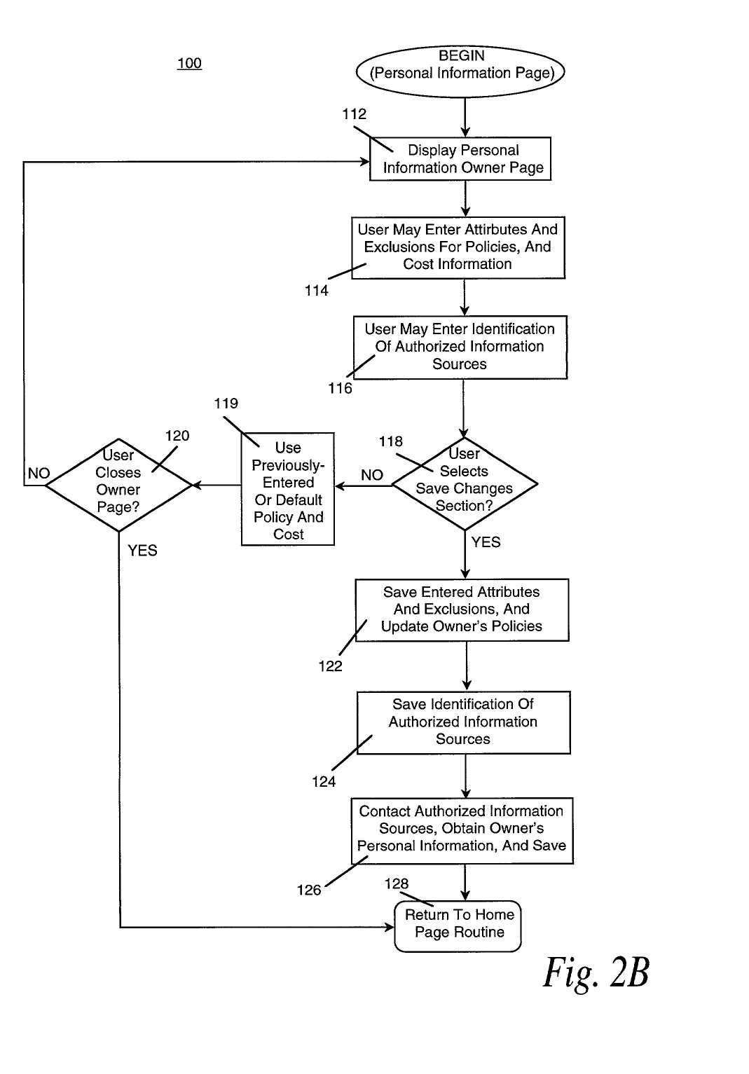

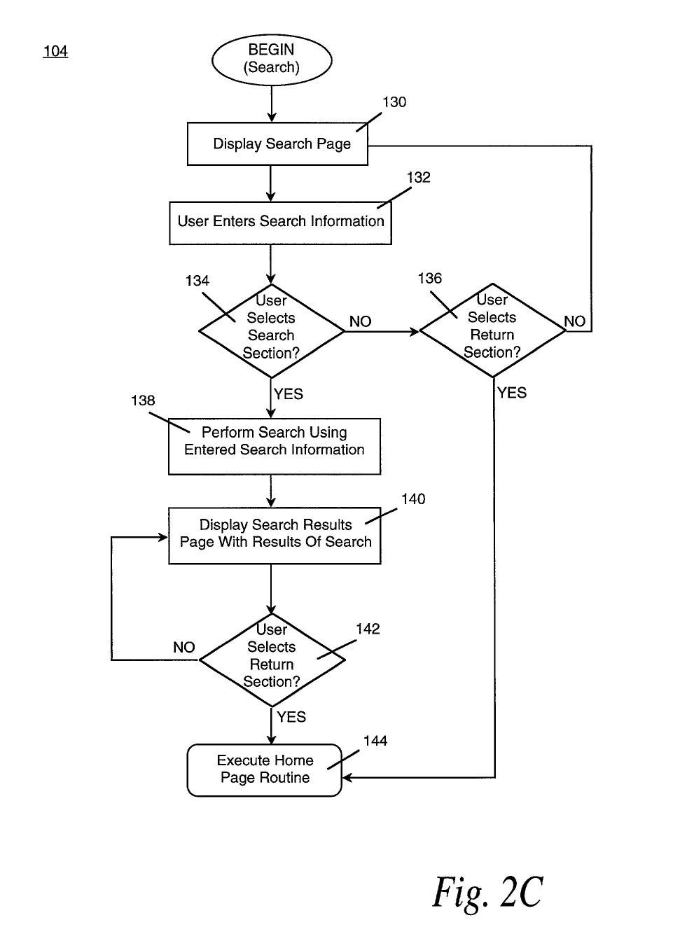

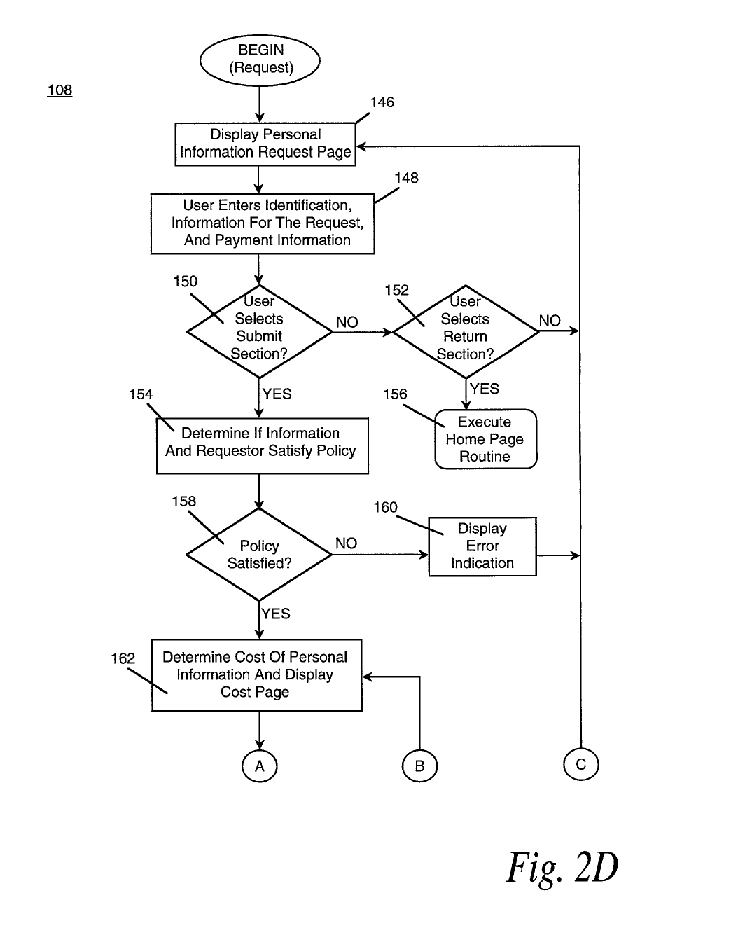

Server 66 stores a database structure in secondary storage 80, for example, for storing and maintaining information for selling personal information. Any type of database structure may be used, such as a relational database or an object-oriented database. Processor 82 may execute one or more applications 74 in order to provide the functions shown in the flow charts of FIGS. 2A-2E and to provide the web pages shown in the screens of FIGS. 3A-3G. Although only one server is shown, system 40 may use multiple servers as necessary or desired to support the users and may also use back-up or redundant servers to prevent network downtime in the event of a failure of a particular server.

FIGS. 3A-3G are screens illustrating how users may interact with the system, and these screens may be displayed on display devices associated with the users' computers. The term “screen” refers to any visual element or combinations of visual elements for displaying information; examples include, but are not limited to, user interfaces on a display device or information displayed in web pages or in windows on a display device. The screens may be formatted, for example, as web pages in HyperText Markup Language (HTML), or in any other suitable form for presentation on a display device depending upon applications accessed by users to interact with the system.

The screens include various sections, as explained below, to provide information or to receive information or commands. The term “section” with respect to screens refers to a particular portion of a screen, possibly including the entire screen. Sections are selected, for example, to enter information or commands or to retrieve information or access other screens. The selection may occur, for example, by a using a cursor-control device to “click on” or “double click on” the section; alternatively, sections may be selected by entering a series of key strokes or in other ways such as through voice commands or use of a touch screen. In addition, although the screens shown in FIGS. 3A-3G illustrate a particular arrangement and number of sections in each screen, other arrangements are possible and different numbers of sections in the screens may be used to accomplish the same or similar functions of displaying information and receiving information or commands. Also, the same section may be used for performing a number of functions, such as both displaying information and receiving a command.

The processing to support the screens in FIGS. 3A-3G is shown in the flow charts of FIGS. 2A-2E. The processing may be implemented in software, such as software modules, for execution by computers or other machines.

Although machine 46 and server 66 are depicted with various components, one skilled in the art will appreciate that this machine and the server can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as machine 46 and server 66, to perform a particular method.

### Method for Selling Personal Information

FIGS. 2A-2E are flow charts of routines implemented by system 40 for managing the sale of personal information according to method 10 illustrated in FIG. 1A. FIGS. 3A-3G are diagrams of screens that may be presented to requester 16 and owner 14 through machines 46 and 48 for use in the sale of personal information. As identified above, these screens may be presented in web browsers on a display device within a computer system. The routines identified in the flow charts of FIGS. 2A-2E may be executed by processor 82 in server 66 when interacting with web browsers within the user machines 46 and 48.

FIG. 2A is a flow chart of a home page routine 90 for execution by server 66. Routine 90 may be used in displaying a home page screen as shown in FIG. 3A when a user first logs onto or otherwise accesses the server 66 through network 70.

In routine 90, the system, such as that shown in FIG. 1B, displays personal information home page 200 (step 94). Home page screen 200 includes a section 202 for use in requesting personal information, a section 204 for use in searching owners, and a section 206 for use by owners in accessing options and information related to their own personal information.

As a potential parallel process, server 66 also receives or records personal information, associates it with owners in the database, and stores the personal information (step 92). The system can both receive and record personal information. This step may occur at any time within the process and represents the receipt of authorized personal information 20 from information source 18. The system may receive the personal information from the information sources in a number of ways such as through e-mail or an encrypted electronic communication, in printed form through a mail or other delivery service, or verbally through a telephone communication. As a part of this step, the system may transmit the owner's authorization to the information source, if not communicated directly to the information source by the owner. The system records the personal information if it also acts as an information source such as, for example, a credit card company recording credit card purchases. This receipt or recordation of personal information provides validation of the personal information through a trusted third party, meaning that the system does not receive the personal information directly from the owner.

The system determines whether the user selects owner section 206 (step 96). If so, the system determines whether the user has correctly entered a name in section 208 and an associated password in section 210. The name entered in section 208 may correspond with the name or other identifier for the owner of the personal information, and a password may be used in section 210 to ensure security of the personal information for that owner. If the user correctly entered the required information, the system executes a personal information page routine 100. Otherwise, the system continues to display home page screen 200 and does not advance to the personal information page routine.

The system determines if the user selects search section 204 (step 102); if so, the system executes a search routine 104. The system also determines if the user selects request personal information section 202 (step 106); if so, the system executes a request routine 108. If the user closes home page screen 200 (step 110), the system may disconnect its electronic connection with the user's web browser.

FIG. 2B is a flow chart of personal information page routine 100 executed upon a user's selection of owners section 206 along with entry of correct information in sections 208 and 210. In routine 100, the system displays a personal information owner screen 212 as shown in FIG. 3B (step 112). The user may then enter attributes and exclusions for a policy within attributes section 214 and exclusions section 216, and also enter cost information in section 219 (step 114). The policy corresponds with policy 24 illustrated in FIG. 1A. The user may also enter the identification of authorized information sources within information sources section 218 (step 116). The identification of authorized information sources can include an associated form for the owner to expressly provide for release of the owner's personal information and the conditions of its release.

The attributes and exclusions specify a particular policy under which the owner's personal information may be sold to requesters. Attributes may specify required characteristics or demographics of a requester required to receive the owner's personal information, and exclusions may specify particular requesters, characteristics, demographics, or other information by which a requester is not permitted to receive the owner's personal information. The owner may also specify a cost of the personal information, which can include a particular monetary amount per sale. Ifa policy and cost is not specified, the system can use a default policy and cost. The default policy may include, for example, permitting any requestor to receive requested personal information of the owner, provided sufficient cost is obtained.

By specifying a policy and cost, individual owners can obtain more control over the sale and distribution of their personal information. For example, they can set the cost at a high level to obtain more credit or payment from the sale of their personal information and discourage some requesters from obtaining it. If the trusted third party is a credit card company that makes the sale of personal information available to its card holders, then owners can specify a policy that no requestor is permitted to obtain their personal information if they do not wish to sell it.

If the user selects “save” section 220 in screen 212 (step 118), the system saves the entered attributes and exclusions and updates the owners policy in the database (step 122). The system also saves identification of the authorization information sources entered in information sources section 218 (step 124). If the user does not save the changes, the system uses previously-entered or default policy and cost information (step 119). If the user closes the personal information owner screen 212 (step 120), the system returns to home page routine (step 128); otherwise, if the user does not close the personal information owner screen 212 (step 120), the system continues to display the screen and wait for input.

If information sources were entered, the system electronically, or through another distribution medium, contacts the information sources, obtain the owner's personal information from them, and save the personal information in the database (step 126). This step may involve the same actions as described with respect to step 92. The system then returns to the home page routine (step 128). The personal information and associated policies can be stored, for example, in secondary storage 80 in a database such as through use of a relational database structure. Therefore, the system can associate each owner with the owner's personal information, policy, and credit amounts for sales of the personal information.

Table 1 illustrates an exemplary database structure for storing the personal information or, alternatively, specifying a link or pointer to another data structure that stores the actual personal information. As shown in Table 1, the personal information for each owner may be divided and stored according to various categories, and each category can be associated with its own policy and cost controlling the sale of the associated personal information. Categories may include, for example, the types of personal information identified above and such categories as assets, earnings, loans, shopping habits, and credit card purchases. When an owner specifies a policy and cost in step 114, the owner can optionally specify the individual policies and cost for each category of personal information. Therefore, the owner can control which type of personal information is sold and, for example, set a higher cost for more sensitive information.

In order to receive the individual policy and cost information, the system may use multiple screens, similar to screen 212, for each category and display an indication of the category to the user. The user may navigate the screens using, for example, the “back” and “forward” commands in a web browser.

TABLE 1

| | | | | | |
|---|---|---|---|---|---|
| 1 | owner 1 | personal information, category 1 | policy 1 | cost 1 | credit amount |
| | | personal information, category 2 | policy 2 | cost 2 | credit amount |
| | | . . . | | | |
| | | personal information, category N | policy N | cost N | credit amount |
| 2 | owner 2 | personal information, category 1 | policy 1 | cost 1 | credit amount |
| | | personal information, category 2 | policy 2 | cost 2 | credit amount |
| | | . . . | | | |
| | | personal information, category N | policy N | cost N | credit amount |
| | . . . | | | | |
| N | owner N | personal information, category 1 | policy 1 | cost 1 | credit amount |
| | | personal information, category 2 | policy 2 | cost 2 | credit amount |
| | | . . . | | | |
| | | personal information, category N | policy N | cost N | credit amount |

Personal information owner screen 212 also illustrates a purchases section 222 by which the owner may obtain information relating to purchases of the owner's personal information. For example, it may list identification of the requesters in section 224 and the corresponding dates of the requests in section 226. Section 222 is optional in that the system need not display the identity of the requestors and instead can maintain that information confidential. Table 2 provides an exemplary database structure for storing the information for display in section 222 and associating it with the corresponding owners. As shown in Table 2, the system can display all requesters, including those who were not permitted to purchase the personal information based upon policy; alternatively, it can display only those requesters who were permitted to purchase the personal information.

TABLE 2

| | | | | |
|---|---|---|---|---|
| 1 | owner 1 | requestor 1 | date of request | information sold (yes/no) |
| | | requestor 2 | date of request | information sold (yes/no) |
| | | . . . | | |
| | | requestor N | date of request | information sold (yes/no) |
| 2 | owner 2 | requestor 1 | date of request | information sold (yes/no) |
| | | requestor 2 | date of request | information sold (yes/no) |
| | | . . . | | |
| | | requestor N | date of request | information sold (yes/no) |
| | . . . | | | |
| N | owner N | requestor 1 | date of request | information sold (yes/no) |
| | | requestor 2 | date of request | information sold (yes/no) |
| | | . . . | | |
| | | requestor N | date of request | information sold (yes/no) |

FIG. 2C is a flow chart of search routine 104 executed upon a user's selection of search section 204 in home page screen 200. In routine 104, the system displays a search screen 228 as shown in FIG. 3C (step 130). The user may then enter search information identifying an owner, such as a name to search entered in name section 230 (step 132). If the user then selects search section 232 (step 134), the system performs a search of the database using the information entered in search section 230 (step 138). For example, the system can search through the column identifying the owners in the database structure shown in Table 1 to determine if a match exists. The system may use any number of search techniques for searching through the database of owners to determine if an identification of an owner corresponds with the information entered in section 230.

The system displays search results within search result screen 236 as shown in FIG. 3D (step 140). In search results screen 236, the system may display the results of the search in section 238 by, for example, listing identification of any owners corresponding with the information entered in section 230 or, if no matches were found, indicating such information in section 238. If the user then selects return section 240 (step 142), the system executes the home page routine 90 (step 144). If the user likewise did not request a search but selected return section 234 in search screen 228 (step 136), the system executes the home page routine 90 (step 144).

FIGS. 2D and 2E are a flow chart of a request personal information routine 108 executed upon a user's selection of request section 202 in home page screen 200. In routine 108, the system displays a personal information request screen 242 as shown in FIG. 3E (step 146). The user may then enter identification information for the request along with payment information (step 148). In particular, the user may enter the name or other identifying information of an owner in section 244 for which the requester would like the purchase personal information. The requester may also specify the types of personal information requested such as all information as specified in section 252, specific types of information as specified in section 254, or other information as specified in section 258. The requester may select types of information by clicking on an adjacent box in order to place a check mark or other indicator in that box. For example, user may select box 246 to request all information, select box 248 to request specific types of information, or select box 250 to select other information. The specific types of information 254 may be specified, for example, in a pull-down menu accessed by selection of an indicator 256.

The requester may also be required to enter an identification in section 260 and payment information such as a credit card number in section 262. If the user then selects submit section 264 (step 150), the system determines if the personal information and requestor satisfy the policy (step 154). For example, the system determines if that the requester satisfies the attributes and is not within exclusions as specified by the owner. Also, the system may determine if the requester has entered all the required information including the payment information.

If the policy and any other requirements are satisfied (step 158), the system determines the cost of the personal information and displays it in a cost screen 268 shown in FIG. 3F (step 162). In particular, the system may display in section 270 the cost of the personal information as determined by the owner or a default amount determined by the system and stored in the database such as through use of the database structure shown in Table 1. The cost can include an aggregate cost determined by adding together the cost of the personal information for each category specified by the requester, or by adding costs for all categories if the requestor specified all personal information.

If the user selects “yes” section 272 to proceed (step 164), the system retrieves the requested information (step 168) and displays in a results screen 276 shown in FIG. 3G (step 170). The system may use section 278 for displaying the requested personal information. The system also assesses the cost of the personal information to the requester (step 172) and credits the cost or a portion of it to the owner (step 174). If the user the selects “yes” section 280 in screen 276 (step 176), the system returns to step 146 to display the personal information request screen 242 and possibly execute another request. Otherwise, if the user selects “no” section 282 in screen 276 (step 178), the system executes the home page routine 90 (step 180).

If the user selected “no” section 274 in screen 268 and did not want to proceed after viewing the cost of the personal information (step 166), the system returns to step 146 to display the personal information request screen 242.

Accordingly, the system manages selling of personal information through a trusted third party to validate and process the sale of the personal information. The trusted third party validates personal information received from an owner or other information source, and the trusted third party can validate personal information through recording it as generated by the owner. In response to a request for personal information, the trusted third party may provide the personal information to the requester and in return provide payment or credit to the owner of the personal information.

While the present invention has been described in connection with an exemplary embodiment, it will be understood that many modifications will be readily apparent to those skilled in the art, and this application is intended to cover any adaptations or variations thereof. For example, different labels for the various features, screen sections, and methods, and different types of servers, information source machines, and user machines may be used without departing from the scope of the invention. This invention should be limited only by the claims and equivalents thereof.

What is claimed is:

1. A method for selling personal information, comprising:
receiving personal information of an owner of the personal information;
specifying a policy related to sale of the personal information;
validating the personal information; and
selectively providing the validated personal information in response to a request and based upon the policy.

2. The method of claim 1 wherein the specifying the policy step includes specifying attributes required of a requestor in order to receive the personal information.

3. The method of claim 2 wherein the specifying the policy step includes specifying exclusions related to the sale of the personal information.

4. The method of claim 1, further including specfying a cost of the personal information, and wherein the providing step further includes selectively providing the validated personal information based upon the cost.

5. The method of claim 4 wherein the providing step includes:
assessing the cost to a requester submitting the request; and
crediting at least a portion of the cost to the owner.

6. The method of claim 1 wherein the receiving step includes receiving information related to credit card purchases, shopping habits, web browsing habits, assets, or finances of the owner.

7. The method of claim 1 wherein the receiving step includes recording an indication of electronic purchases by the owner.

8. A method for selling personal information, comprising:
receiving from a requestor a request for personal information of a particular owner of the personal information;
specifying a policy related to sale of the personal information;
validating the personal information through a trusted third party;
determining if the requestor is permitted to receive the requested personal information based upon the policy; and
providing the requested personal information to the requestor if the requestor is permitted to received the personal information.

9. The method of claim 8 wherein the specifying step includes specifying attributes related to the sale of the personal information.

10. The method of claim 9 wherein the specifying step includes specifying exclusions related to the sale of the personal information.

11. The method of claim 8, further including providing payment to the owner for the sale of the personal information.

12. The method of claim 11 wherein the providing step includes crediting an account associated with the owner.

13. The method of claim 8, further including receiving a request to search for a particular owner having personal information for sale.

14. An apparatus for selling personal information, comprising:
a receive module that receives personal information of an owner of the personal information;
a policy module that specifies a policy related to sale of the personal information;
a validate module that validates the personal information; and
a provide module that selectively provides the validated personal information in response to a request and based upon the policy.

15. The apparatus of claim 14 wherein the policy module includes a module that specifies attributes required of a requestor in order to receive the personal information.

16. The apparatus of claim 14 wherein the policy module includes a module that specifies exclusions related to the sale of the personal information.

17. The apparatus of claim 14, further including a cost module that specifies a cost of the personal information, and wherein the provide module further includes a module that selectively provides the validated personal information based upon the cost.

18. The apparatus of claim 17 wherein the provide module includes:
a module that assesses the cost to a requestor submitting the request; and
a module that credits at least a portion of the cost to the owner.

19. The apparatus of claim 14 wherein the receive module includes a module that receives information related to credit card purchases, shopping habits, web browsing habits, assets, or finances of the owner.

20. The apparatus of claim 14 wherein the receive module includes a module that records an indication of electronic purchases by the owner.
